(19) United States
(12) Patent Application Publication
(10) Pub. No.: US 2018/0347793 A1
(43) Pub. Date: Dec. 6, 2018

(54) ILLUMINATION APPARATUS AND SENSOR UNIT

(71) Applicant: CANON COMPONENTS, INC., Kodama-gun (JP)

(72) Inventors: Ryo NATSUI, Saitama (JP); Junya KINOSHITA, Saitama (JP); Hidemasa YOSHIDA, Saitama (JP)

(21) Appl. No.: 15/992,828

(22) Filed: May 30, 2018

(30) Foreign Application Priority Data
May 31, 2017 (JP) 2017-108366

(51) Int. Cl. F21V 21/005; H05B 37/02; F21V 23/06; F21V 15/01; H04N 1/028

(52) U.S. Cl. CPC F21V 21/005; H05B 37/0218; F21Y 2115/10; F21V 15/01; H04N 1/02865; F21V 23/06

(57) ABSTRACT

An illumination apparatus has a first longitudinal light source section that includes a first substrate and a second substrate on which a plurality of light sources are arranged in a line in the longitudinal direction, and a second longitudinal light source section that includes a third substrate and a fourth substrate on which a plurality of light sources are arranged in a line in the longitudinal direction. The first longitudinal light source section and the second longitudinal light source section are arranged side by side in the short direction. The plurality of light sources on the first longitudinal light source section and the plurality of light sources on the second longitudinal light source section are displaced from each other in the longitudinal direction of the first longitudinal light source section and the second longitudinal light source section.

### CROSS-REFERENCE TO RELATED APPLICATIONS

This application is based upon and claims the benefit of priority of the prior Japanese Patent Application No. 2017-108366, filed on May 31, 2017, the entire contents of which are incorporated herein by reference.

### BACKGROUND OF THE INVENTION

### Field of the Invention

The present invention relates to an illumination apparatus and a sensor unit. In particular, it relates to an illumination apparatus and a sensor unit that have a plurality of substrates on which a plurality of light sources are arranged.

### Description of the Related Art

Some illumination apparatuses and sensor units have a substrate on which a plurality of light sources such as LEDs are arranged. Patent Document 1 discloses an image sensor unit that has two substrates on which a plurality of LEDs are linearly arranged. An arrangement is illustrated in the document in which the interval between the LEDs differs between inside and outside the reading region. Patent Document 2 discloses an illumination apparatus that has two LED substrates having a rectangular shape with the same dimensions. An arrangement is illustrated in the document in which the LED elements are arranged on the LED substrate with a higher density in the end portions than in the middle portion in the longitudinal direction.

Patent Document 1: Japanese Laid-Open Patent Publication No. 2009-246663

Patent Document 2: Japanese Laid-Open Patent Publication No. 2015-53190

### SUMMARY OF THE INVENTION

With such illumination apparatuses and sensor units, there is a demand for prevention of a reduction of the light quantity at the end portions in the longitudinal direction. The present invention has been devised in view of such circumstances, and an object of the present invention is to prevent a reduction of the light quantity at end portions in the longitudinal direction.

To attain the object described above, the present invention provides an illumination apparatus comprising a first longitudinal light source section that has a first substrate and a second substrate, which have an elongated shape and are arranged with end surfaces thereof in a longitudinal direction facing each other and on which a plurality of light sources are arranged in a line in the longitudinal direction, and a second longitudinal light source section that has a third substrate and a fourth substrate, which have an elongated shape and are arranged with end surfaces thereof in a longitudinal direction facing each other and on which a plurality of light sources are arranged in a line in the longitudinal direction, wherein the first longitudinal light source section and the second longitudinal light source section are arranged side by side in a short direction, and the plurality of light sources on the first longitudinal light source section and the plurality of light sources on the second longitudinal light source section are displaced from each other in the longitudinal direction of the first longitudinal light source section and the second longitudinal light source section.

### BRIEF DESCRIPTION OF THE DRAWINGS

FIG. 1 is a schematic diagram showing an example of a configuration of essential parts of an illumination apparatus;

FIG. 2 is a schematic diagram showing an example of a configuration of an image sensor unit;

FIG. 3 is a schematic diagram showing the example of the configuration of the image sensor unit; and

FIG. 4 is a graph for illustrating an example and a comparative example.

### DETAILED DESCRIPTION OF THE PREFERRED EMBODIMENTS

In the following, an embodiment of the present invention will be described in detail with reference to the drawings.

### (Illumination Apparatus)

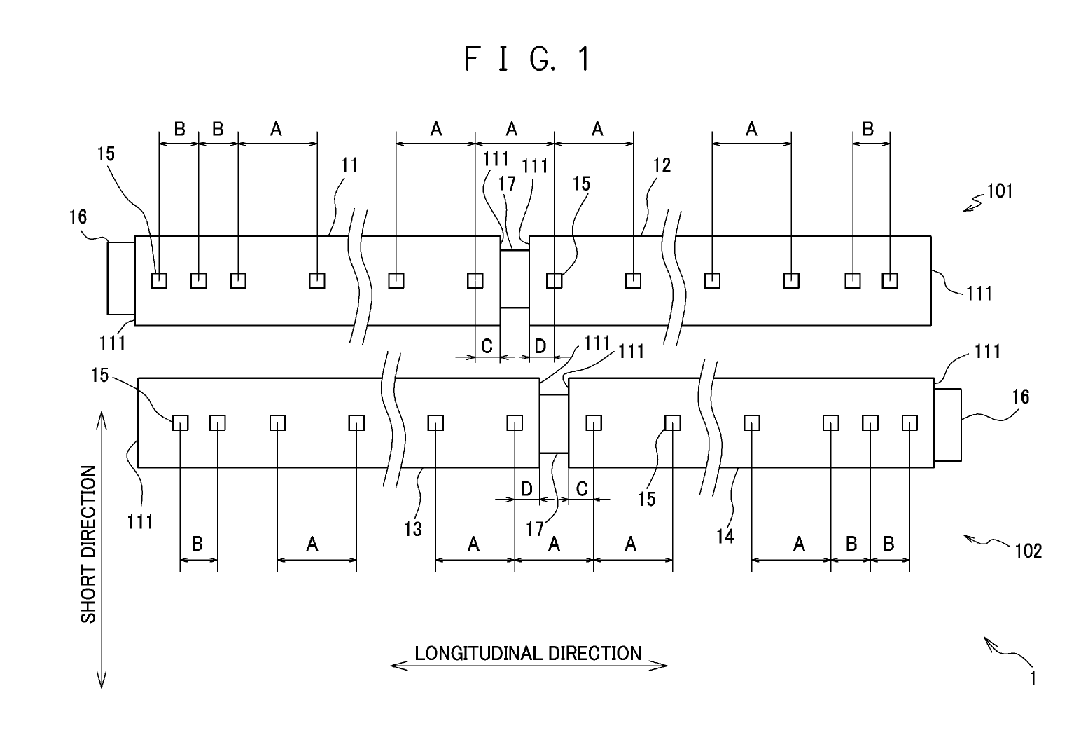

FIG. 1 is a schematic diagram showing an example of a configuration of essential parts of an illumination apparatus 1 according to an embodiment of the present invention. As shown in FIG. 1, the illumination apparatus 1 has a first longitudinal light source section 101 and a second longitudinal light source section 102, both of which have an elongated shape. The first longitudinal light source section 101 has a first substrate 11 and a second substrate 12, both of which have an elongated shape. The second longitudinal light source section 102 has a third substrate 13 and a fourth substrate 14, both of which have an elongated shape. In the first longitudinal light source section 101, the first substrate 11 and the second substrate 12 are arranged in a line with end surfaces 111 thereof in the longitudinal direction facing each other. In the second longitudinal light source section 102, the third substrate 13 and the fourth substrate 14 are arranged in a line with end surfaces 111 thereof in the longitudinal direction facing each other. The first longitudinal light source section 101 and the second longitudinal light source section are arranged side by side in the short direction so that the longer sides thereof are in parallel with each other. The first substrate 11 of the first longitudinal light source section 101 and the fourth substrate 14 of the second longitudinal light source section 102 are located on the opposite sides in the longitudinal direction of the illumination apparatus 1. The second substrate 12 of the first longitudinal light source section 101 and the third substrate 13 of the second longitudinal light source section 102 are located on the opposite sides in the longitudinal direction of the illumination apparatus 1.

The first to fourth substrates 11 to 14 all have an elongated shape. A plurality of light sources 15 are arranged in the longitudinal direction on a surface of each of the first to fourth substrates 11 to 14. The plurality of light sources 15 can be LEDs, for example. However, the plurality of light sources 15 are not limited to the LEDs. The plurality of light sources 15 can be any of well-known various light emitting elements. The number of the light sources 15 arranged on the first to fourth substrates 11 to 14 is not particularly limited. Furthermore, although FIG. 1 shows a configuration in which the plurality of light sources 15 are linearly arranged in the longitudinal direction on the first to fourth substrates 11 to 14, the present invention is not limited to such a configuration. For example, the plurality of light sources 15 may be displaced in the short direction in a zigzag configuration.

In the first longitudinal light source section 101, the interval in the longitudinal direction between the plurality of light sources 15 on the first substrate 11 differs between some (a plurality) of the light sources 15 located in a longitudinal end portion that is away from the second substrate 12 and the other light sources 15 located in the other portions. For convenience of explanation, the interval between the light sources 15 located in the other portions than the longitudinal end portion that is away from the second substrate 12 will be referred to as a first interval A, and the interval between the light sources 15 located in the longitudinal end portion that is away from the second substrate 12 will be referred to as a second interval B. The interval in the longitudinal direction between the plurality of light sources 15 on the second substrate 12 differs between some of the light sources 15 located in a longitudinal end portion that is away from the first substrate 11 and the other light sources 15. The interval between the light sources 15 located in the other portions than the longitudinal end portion that is away from the first substrate 11 will be referred to as a first interval A, and the interval between the light sources 15 located in the longitudinal end portion that is away from the first substrate 11 will be referred to as a second interval B. The first interval A for the first substrate 11 and the first interval A for the second substrate 12 are equal. Similarly, the second interval B for the first substrate 11 and the second interval B for the second substrate 12 are equal. The second interval B is smaller than the first interval A. For example, the second interval B is a half of the first interval A. However, the intervals A and B are not specifically limited.

The number of the light sources 15 arranged at the second intervals B in the longitudinal end portion of the first substrate 11 that is away from the second substrate 12 and the number of the light sources 15 arranged at the second intervals B in the longitudinal end portion of the second substrate 12 that is away from the first substrate 11 differ from each other. In the example shown in FIG. 1, the number of the light sources 15 arranged at the second intervals B in the longitudinal direction on the first substrate 11 is three, and the number of the light sources 15 arranged at the second intervals B in the longitudinal direction on the second substrate 12 is two. However, the number of the light sources 15 arranged at the intervals B is not specifically limited.

As shown in FIG. 1, the interval in the longitudinal direction between the light source 15 on the first substrate 11 that is located at the end closer to the second substrate 12 and the light source 15 on the second substrate 12 that is located at the end closer to the first substrate 11 is equal to the first interval A. Therefore, a distance C from the light source 15 on the first substrate 11 that is located at the end closer to the second substrate 12 to the longitudinal end surface 111 of the first substrate 11 (the end surface 111 facing the second substrate 12) is smaller than the first interval A. Similarly, a distance D from the light source 15 on the second substrate 12 that is located at the end closer to the first substrate 11 to the longitudinal end surface 111 of the second substrate 12 (the end surface 111 facing the first substrate 11) is smaller than the first interval A.

Therefore, in the first longitudinal light source section 101, the plurality of light sources 15 are arranged at regular, first intervals A in the longitudinal direction except in the longitudinal end portions. In the longitudinal end portions, the light sources 15 are arranged in a line in the longitudinal direction at second intervals B, which are smaller than the first interval A. The number of the light sources 15 arranged at second intervals B differs between one longitudinal end portion and the other longitudinal end portion of the first longitudinal light source section 101.

In the second longitudinal light source section 102, the interval in the longitudinal direction between the plurality of light sources 15 on the third substrate 13 differs between some of the light sources 15 located in a longitudinal end portion that is away from the fourth substrate 14 and the light sources 15 located in the other portions. As with the first longitudinal light source section 101, the interval between the light sources 15 located in the other portions than the longitudinal end portion that is away from the fourth substrate 14 will be referred to as a first interval A, and the interval between the light sources 15 located in the longitudinal end portion that is away from the fourth substrate 14 will be referred to as a second interval B. The interval in the longitudinal direction between the plurality of light sources 15 on the fourth substrate 14 differs between some of the light sources 15 located in a longitudinal end portion that is away from the third substrate 13 and the light sources 15 located in the other portions. The interval between the light sources 15 located in the other portions than the longitudinal end portion that is away from the third substrate 13 will be referred to as a first interval A, and the interval between the light sources 15 located in the longitudinal end portion that is away from the third substrate 13 will be referred to as a second interval B. The first interval A for the third substrate 13 and the first interval A for the fourth substrate 14 are equal. Similarly, the second interval B for the third substrate 13 and the second interval B for the fourth substrate 14 are equal. With the third substrate 13 and the fourth substrate 14, the second interval B is also smaller than the first interval A. Furthermore, the first interval A for the third substrate 13 and the fourth substrate 14 is equal to the first interval A for the first substrate 11 and the second substrate 12. Similarly, the second interval B for the third substrate 13 and the fourth substrate 14 is equal to the second interval B for the first substrate 11 and the second substrate 12.

As shown in FIG. 1, the interval in the longitudinal direction between the light source 15 on the third substrate 13 that is located at the end closer to the fourth substrate 14 and the light source 15 on the fourth substrate 14 that is located at the end closer to the third substrate 13 is equal to the first interval A. Therefore, a distance C from the light source 15 on the fourth substrate 14 that is located at the end closer to the third substrate 13 to the longitudinal end surface 111 of the fourth substrate 14 (the end surface 111 facing the third substrate 13) is smaller than the first interval A. Similarly, a distance D from the light source 15 on the third substrate 13 that is located at the end closer to the fourth substrate 14 to the longitudinal end surface 111 of the third substrate 13 (the end surface 111 facing the fourth substrate 14) is smaller than the first interval A.

In the second longitudinal light source section 102, the number of the light sources 15 arranged at the second intervals B in the longitudinal end portion of the third substrate 13 that is away from the fourth substrate 14 and the number of the light sources 15 arranged at the second intervals B in the longitudinal end portion of the fourth substrate 14 that is away from the third substrate 13 differ from each other. In the example shown in FIG. 1, the number of the light sources 15 arranged at the second intervals B in the longitudinal direction on the third substrate 13 is two, and the number of the light sources 15 arranged at the second intervals B in the longitudinal direction on the fourth substrate 14 is three.

Therefore, in the second longitudinal light source section 102, the plurality of light sources 15 are arranged at regular, first intervals A in the longitudinal direction except in the longitudinal end portions. In the longitudinal end portions, the light sources 15 are arranged in a line in the longitudinal direction at second intervals B, which are smaller than the first interval A. The number of the light sources 15 arranged at second intervals B differs between one longitudinal end portion and the other longitudinal end portion of the second longitudinal light source section 102.

As shown in FIG. 1, the number of the light sources 15 arranged at second intervals B in the end portion of the first longitudinal light source section 101 on one side of the illumination apparatus 1 differs from the number of the light sources 15 arranged at second intervals B in the end portion of the second longitudinal light source section 102 on the same side of the illumination apparatus 1. To the contrary, the number of the light sources 15 arranged at second intervals B in the longitudinal end portion of the first longitudinal light source section 101 on one side of the illumination apparatus 1 is the same as the number of the light sources 15 arranged at second intervals B in the longitudinal end portion of the second longitudinal light source section 102 on the opposite side of the illumination apparatus 1.

As described above, the first substrate 11 of the first longitudinal light source section 101 and the fourth substrate 14 of the second longitudinal light source section 102 have the same number of light sources 15 arranged at first intervals A and the same number of light sources 15 arranged at second intervals B. The second substrate 12 of the first longitudinal light source section 101 and the third substrate 13 of the second longitudinal light source section 102 have the same number of light sources 15 arranged at first intervals A and the same number of light sources 15 arranged at second intervals B. The first substrate 11 of the first longitudinal light source section 101 and the fourth substrate 14 of the second longitudinal light source section 102 are arranged on the opposite sides of the illumination apparatus 1 in the longitudinal direction. Similarly, the second substrate 12 of the first longitudinal light source section 101 and the third substrate 13 of the second longitudinal light source section 102 are arranged on the opposite sides of the illumination apparatus 1 in the longitudinal direction. Therefore, the first longitudinal light source section 101 and the second longitudinal light source section 102 have the same number of light sources 15 arranged at second intervals B in the respective end portions on the opposite sides of the illumination apparatus 1 in the longitudinal direction, and have different numbers of light sources 15 arranged at second intervals B in the respective end portions on the same side of the illumination apparatus 1 in the longitudinal direction.

As shown in FIG. 1, the light sources 15 arranged at first intervals A on the first substrate 11 and the second substrate 12 of the first longitudinal light source section 101 are displaced from the light sources 15 arranged at first intervals A on the third substrate 13 and the fourth substrate 14 of the second longitudinal light source section 102 in the longitudinal direction of the illumination apparatus 1. Similarly, the light sources 15 arranged at second intervals B on the first substrate 11 and the second substrate 12 of the first longitudinal light source section 101 are displaced from the light sources 15 arranged at second intervals B on the third substrate 13 and the fourth substrate 14 of the second longitudinal light source section 102 in the longitudinal direction of the illumination apparatus 1.

As described above, the intervals between the light sources 15 located in the end portions of the illumination apparatus 1 in the longitudinal direction are smaller than the intervals between the light sources 15 located in the other portions. Therefore, a reduction of the light quantity at the end portions in the longitudinal direction can be prevented or reduced. In addition, the light sources 15 in the first longitudinal light source section 101 and the light sources 15 in the second longitudinal light source section 102 are displaced from each other in the longitudinal direction. Therefore, a local nonuniformity of the light quantity (that is, a difference in light quantity between the positions at which the light sources 15 are arranged and the other positions) can be reduced.

The first substrate 11 of the first longitudinal light source section 101 and the fourth substrate 14 of the second longitudinal light source section 102 have the same number of light sources 15 arranged at first intervals A and the same number of light sources 15 arranged at second intervals B. The second substrate 12 of the first longitudinal light source section 101 and the third substrate 13 of the second longitudinal light source section 102 have the same number of light sources 15 arranged at first intervals A and the same number of light sources 15 arranged at second intervals B. The first interval A is the same for all of the first to fourth substrates 11 to 14, and the second interval B is also the same for all of the first to fourth substrates 11 to 14. With such a configuration, the first substrate 11 of the first longitudinal light source section 101 can be used as the fourth substrate 14 of the second longitudinal light source section 102, and vice versa. Similarly, the second substrate 12 of the first longitudinal light source section 101 can be used as the third substrate 13 of the second longitudinal light source section 102, and vice versa. With such a configuration, therefore, the variety of substrates of the illumination apparatus 1 can be reduced.

Furthermore, the first substrate 11 of the first longitudinal light source section 101 and the fourth substrate 14 of the second longitudinal light source section 102 can also be configured the same in other respects than the arrangement (number and interval) of the light sources 15. Similarly, the second substrate 12 of the first longitudinal light source section 101 and the third substrate 13 of the second longitudinal light source section 102 can also be configured the same in other respects than the arrangement (number and interval) of the light sources 15. For example, a connector 16 that receives electric power required for the light sources 15 to emit light supplied from outside (a connector to connect a power supply, for example) may be provided on each of the first substrate 11 of the first longitudinal light source section 101 and the fourth substrate 14 of the second longitudinal light source section 102.

Furthermore, the second substrate 12 of the first longitudinal light source section 101 and the third substrate 13 of the second longitudinal light source section 102 may be electrically connected to the first substrate 11 of the first longitudinal light source section 101 and the fourth substrate 14 of the second longitudinal light source section 102, respectively, by a connection wire 17 such as an FPC. Then, the second substrate 12 of the first longitudinal light source section 101 and the third substrate 13 of the second longitudinal light source section 102 can receive electric power via the first substrate 11 of the first longitudinal light source section 101 and the fourth substrate 14 of the second longitudinal light source section 102, respectively. In this way, the first substrate 11 of the first longitudinal light source section 101 and the fourth substrate 14 of the second longitudinal light source section 102 may have the same configuration with the connector 16. The second substrate 12 of the first longitudinal light source section 101 and the third substrate 13 of the second longitudinal light source section 102 may have the same configuration in which the substrates have no connector 16 for external connection and are connected to their respective counterpart substrates (the first substrate 11 and the third substrate 13, respectively) by the connection wire 17.

Furthermore, the first substrate 11 of the first longitudinal light source section 101 and the fourth substrate 14 of the second longitudinal light source section 102 may have the same shape, the same dimensions, or the same wiring pattern. Similarly, the second substrate 12 of the first longitudinal light source section 101 and the third substrate 13 of the second longitudinal light source section 102 may have the same shape, the same dimensions, or the same wiring pattern.

With such a configuration, the first longitudinal light source section 101 and the second longitudinal light source section 102 can be formed by the same components. The illumination apparatus 1 can be formed by arranging the first longitudinal light source section 101 and the second longitudinal light source section 102 formed by the same components in the opposite orientations in such a manner that the plurality of light sources 15 arranged thereon are displaced from each other in the longitudinal direction. Therefore, the variety of parts of the illumination apparatus 1 can be reduced.

### (Sensor Unit)

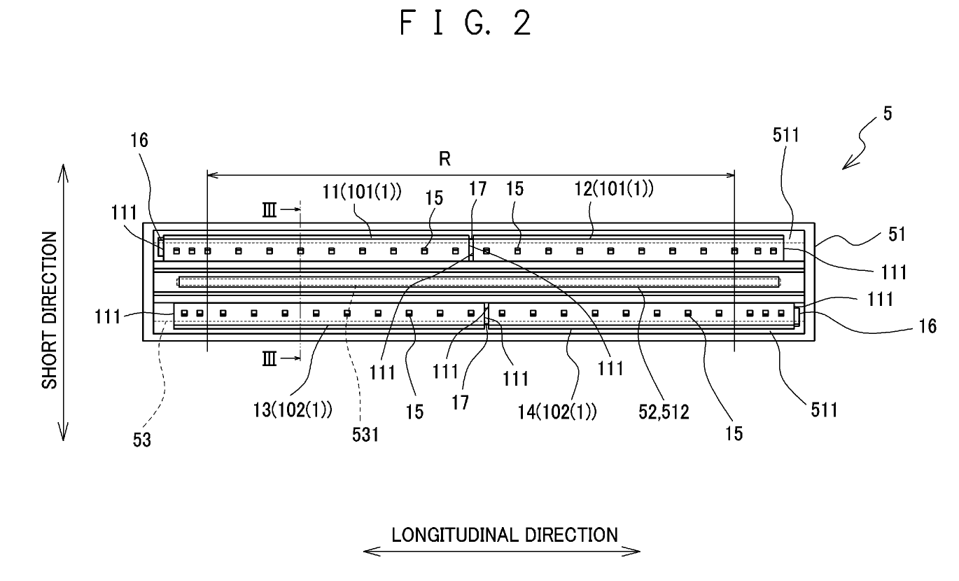

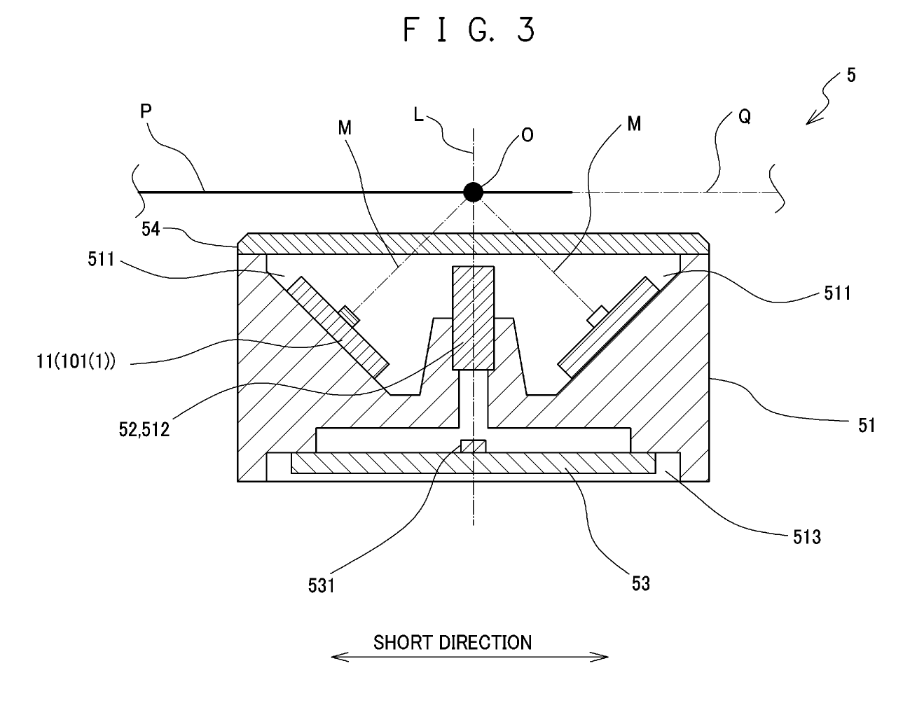

Next, an example of a configuration of a sensor unit 5 will be described. FIG. 2 is a schematic plan view showing an example of the configuration of the sensor unit 5 viewed from the side of an object P to be read. FIG. 3 is a cross-sectional view taken along the line indicated by arrows in FIG. 2. As shown in FIGS. 2 and 3, the sensor unit 5 includes a housing 51, the illumination apparatus 1, a light condensing member 52, a sensor substrate 53 and a main body cover 54. In FIG. 2, the main body cover 54 is not shown. The sensor unit 5 has an elongated shape as a whole. The longitudinal direction of the sensor unit 5 is the main-scan direction, and one of the short directions perpendicular to each other is the sub-scan direction. The sensor unit 5 emits light to the object P to be read while moving in the sub-scan direction with respect to the object P to be read and receives (detects) reflection light from the object P to be read. The sensor unit 5 may emit and receive light while the object P to be read is being moved in the short direction (the sub-scan direction) of the sensor unit 5 or while the sensor unit 5 is being moved in the short direction.

The sensor unit 5 incorporates the illumination apparatus 1 described above. That is, the illumination apparatus 1 incorporated in the sensor unit 5 has the first longitudinal light source section 101 and the second longitudinal light source section 102, the first longitudinal light source section 101 has the first substrate 11 and the second substrate 12, and the second longitudinal light source section 102 has the third substrate 13 and the fourth substrate 14.

The light condensing member 52 is an optical member that condenses the light emitted by the illumination apparatus 1 and reflected from the object P to be read onto a line sensor 531 on the sensor substrate 53 described later. The light condensing member 52 may be a rod-lens array, for example. The rod-lens array has a plurality of imaging elements (rod lenses) of an erecting equal magnification type linearly arranged in the longitudinal direction, for example. The light condensing member 52 is not limited to the rod-lens array. The light condensing member 52 can be any optical member that can condense the reflection light from the object P to be read onto the line sensor 531 on the sensor substrate 53 described later.

The sensor substrate 53 is a substrate on which the line sensor 531 is arranged. The sensor substrate 53 has an elongated plate-like shape as a whole, and the line sensor 531 is arranged on one surface. The line sensor 531 has a plurality of photoelectric conversion elements (light receiving elements) linearly arranged in the longitudinal direction. For example, the line sensor 531 is formed by a plurality of photodiode arrays arranged in a line in the longitudinal direction, each photodiode array including a plurality of light receiving parts linearly arranged. The line sensor 531 receives the light emitted by the illumination apparatus 1 and reflected from the object P to be read and generates and outputs an electric signal in response to the received reflection light (that is, performs photoelectric conversion). The line sensor 531 is not limited to the arrangement including the photodiode arrays. The line sensor 531 can be any arrangement that includes a plurality of photoelectric conversion elements linearly arranged in the longitudinal direction.

The housing 51 is a member that functions as a housing of the sensor unit 5. On the side of the housing 51 facing the object P to be read, a longitudinal light source section housing section 511 that can house the first longitudinal light source section 101 of the illumination apparatus 1, a longitudinal light source section housing section 511 that can house the second longitudinal light source section 102 of the illumination apparatus 1, and a light condensing member housing section 512 that can house the light condensing member 52 are provided. On the side of the housing 51 opposite to the side facing the object P to be read, a sensor substrate housing section 513 that can houses the sensor substrate 53 is provided. The light condensing member housing section 512 and the longitudinal light source section housing section 511 are configured to be capable of housing the light condensing member 52 and the first longitudinal light source section 101 and the second longitudinal light source section 102 with the longitudinal direction of the light condensing member 52 and the longitudinal direction of the first longitudinal light source section 101 and the second longitudinal light source section 102 being aligned (in parallel) with each other. As shown in FIGS. 2 and 3, the light condensing member housing section 512 is arranged between the two longitudinal light source section housing sections 511 in the short direction (the sub-scan direction).

The main body cover 54 is a member that is attached to the housing 51 on the side facing the object P to be read. The main body cover 54 is formed by a transparent plate-shaped member, for example. The main body cover 54 functions to protect the devices or members housed in the housing 51 or to prevent foreign matters such as dust from entering the housing 51. When the object P to be read is paper or the like, the main body cover 54 functions to keep the surface of the object P to be read flat. The sensor unit 5 may not have the main body cover 54.

As shown in FIG. 2, the light condensing member 52 is housed and fixed in the light condensing member housing section 512. The first longitudinal light source section 101 and the second longitudinal light source section 102 of the illumination apparatus 1 are housed and fixed in their respective longitudinal light source section housing sections 511. The sensor substrate 53 is housed and fixed in the sensor substrate housing section 513. In this state, when viewed in the longitudinal direction, an optical axis L of the light condensing member 52 intersects with a passage path Q of the object P to be read, and one focal point of the light condensing member 52 is located at, or in the vicinity of, the intersection O (which is actually not a point but a line extending in the longitudinal direction). The optical axis L of the light condensing member 52 passes through the line sensor 531 on the sensor substrate 53, and another focal point of the light condensing member 52 is located on a surface of the line sensor 531 on the sensor substrate 53.

As shown in FIG. 2, when viewed in the longitudinal direction, the first longitudinal light source section 101 and the second longitudinal light source section 102 of the illumination apparatus 1 are located on the opposite sides of the light condensing member 52 in the short direction (the sub-scan direction). When viewed in the longitudinal direction, the first longitudinal light source section 101 and the second longitudinal light source section 102 are inclined are arranged in such a manner that optical axes M of the light emitted from the sections are inclined toward the optical axis L of the light condensing member 52 and pass through the intersection O of the optical axis L of the light condensing member 52 and the passage path Q of the object P to be read or the vicinity of the intersection O.

With such a configuration, the light emitted from the first longitudinal light source section 101 and the second longitudinal light source section 102 of the illumination apparatus 1 is reflected on the surface of the object P to be read, passes through the light condensing member 52 and is incident on the surface of the line sensor 531. The line sensor 531 generates an electric signal in response to the quantity of the incident light. In this way, the sensor unit 5 can read the object P to be read.

As shown in FIG. 2, a range of actual reading of the object P to be read (which is referred to as a reading range R for convenience of explanation) is set in the sensor unit 5. The light condensing member 52 and the line sensor 531 are arranged in such a manner that the light condensing member 52 and the line sensor 531 covers the entire reading range R and both the longitudinal end portions thereof extend beyond the reading range R. The first longitudinal light source section 101 and the second longitudinal light source section 102 of the illumination apparatus 1 are arranged so as to cover the entire reading range R. Specifically, when viewed in the direction of the optical axis of the light condensing member 52, the illumination apparatus 1 is arranged in such a manner that the entire reading range R is included in the region where the plurality of light sources 15 of the first longitudinal light source section 101 and the second longitudinal light source section 102 are arranged. In this case, a configuration is possible in which, in the longitudinal direction, the entire reading range R is included in the region where the light sources 15 are arranged at first intervals A. With such a configuration, a reduction of the quantity of the light emitted to the object P to be read at the longitudinal end portions can be suppressed. A configuration is also possible in which the opposite ends of the reading range R are included in the regions where the light sources 15 are arranged at second intervals B. As described above, in the regions where the light sources 15 are arranged at second intervals B (that is, the opposite longitudinal end portions of the illumination apparatus 1), a reduction of the light quantity is suppressed. Therefore, with such a configuration, a reduction of the quantity of the light emitted to the object P to be read at the longitudinal end portions can be suppressed.

Since a reduction of the emission light quantity at both the longitudinal end portions can be suppressed as described above, the sensor unit 5 according to this embodiment of the present invention can suppress a reduction of the quantity of the light emitted to the object P to be read at both the end portions in the longitudinal direction (the main-scan direction). Therefore, a reduction of the reading accuracy at both the longitudinal end portions can be suppressed.

As shown in FIG. 2, the light condensing member 52 is located between the first longitudinal light source section 101 and the second longitudinal light source section 102 of the illumination apparatus 1 in the short direction (the sub-scan direction). When viewed in the longitudinal direction, the optical axes M of the light emitted from the first longitudinal light source section 101 and the second longitudinal light source section 102 are inclined in the opposite directions toward the optical axis L of the light condensing member 52 and pass through the intersection O of the optical axis L of the light condensing member 52 and the passage path Q of the object P to be read. Therefore, the first longitudinal light source section 101 and the second longitudinal light source section 102 emit light to the object P to be read in different directions. In particular, the first longitudinal light source section 101 and the second longitudinal light source section 102 emit light to the object P to be read from the opposite sides in the short direction (the sub-scan direction).

In this case, when viewed in the longitudinal direction, the first longitudinal light source section 101 and the second longitudinal light source section 102 are preferably arranged in line symmetry (mirror symmetry) with respect to the optical axis L of the light condensing member 52. With such a configuration, the light from the first longitudinal light source section 101 and the light from the second longitudinal light source section 102 can be incident on the surface of the object P to be read at an equal incident angle. Therefore, the quantity of the reflection light can be prevented from varying depending on whether the first longitudinal light source section 101 or the second longitudinal light source section 102 is used. Therefore, in reading the object P to be read while the sensor unit 5 and the object P to be read are moving with respect to each other in the opposite directions along the short direction, for example, a variation of the quantity of the reflection light can be prevented even when the direction of the relative movement is reversed.

With such a configuration, furthermore, even if the surface of the object P to be read is inclined with respect to the passage path Q when viewed in the longitudinal direction, a variation of the quantity of the light incident on the line sensor 531 can be suppressed. That is, when viewed in the longitudinal direction, if the surface of the object P to be read is not inclined with respect to the passage path Q, the light emitted from the first longitudinal light source section 101 and the light emitted from the second longitudinal light source section 102 are incident on the surface of the object P to be read at the same incident angle. Therefore, in this case, the quantity of the light that is emitted from the first longitudinal light source section 101, reflected from the object P to be read and then incident on the line sensor 531 is approximately equal to the quantity of the light that is emitted from the second longitudinal light source section 102, reflected from the object P to be read and then incident on the line sensor 531. On the other hand, if the surface of the object P to be read is inclined with respect to the passage path Q when viewed in the longitudinal direction, the magnitude (the absolute value) of the incident angle on the surface of the object P to be read of one of the light emitted by the first longitudinal light source section 101 and the light emitted by the second longitudinal light source section 102 is greater (smaller) than that of the other. Therefore, in this case, of the quantity of the light that is emitted by the first longitudinal light source section 101, reflected from the object P to be read and then incident on the line sensor 531 and the quantity of the light that is emitted by the second longitudinal light source section 102, reflected from the object P to be read and then incident on the line sensor 531, one for which the magnitude of the incident angle on the surface of the object P to be read has decreased increases, and the other, for which the magnitude of the incident angle has increased, decreases. Therefore, as a whole, a variation of the quantity of the light incident on the line sensor 531 is suppressed. In this way, even if the surface of the object P to be read is inclined with respect to the passage path Q, a variation of the light incident on the line sensor 531 can be suppressed.

### Example

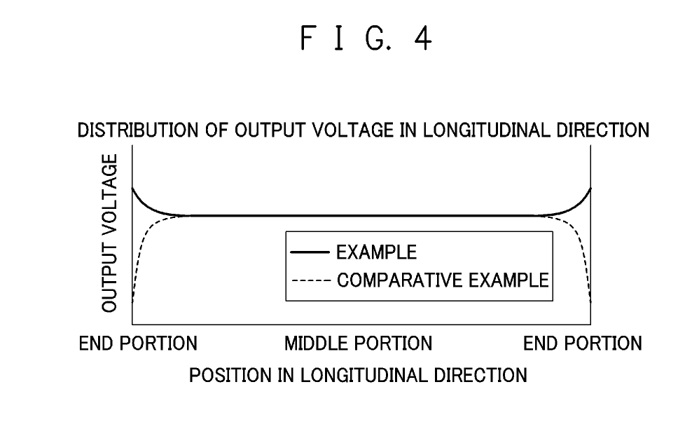

Next, an example of the present invention will be described. FIG. 4 is a graph showing distributions, in the longitudinal direction, of the voltage of the electric signal output from the line sensor 531 for the sensor unit 5 incorporating the illumination apparatus 1 according to the example and a comparative example. The horizontal axis indicates the positions on the line sensor 531 and the illumination apparatus 1 in the longitudinal direction. The voltage of the electric signal depends on the quantity of the received light. This means that, given the same output voltage, the quantity of the received light is the same. In the sensor unit 5 incorporating the illumination apparatus 1 according to the example of the present invention, the second interval B was a half of the first interval A. In addition, on each of the first longitudinal light source section 101 and the second longitudinal light source section 102, three light sources 15 were arranged at second intervals B in one of the longitudinal end portions, and two light sources 15 were arranged at second intervals B in the other longitudinal end portion. On the other hand, in the sensor unit 5 incorporating the illumination apparatus 1 according to the comparative example, the light sources 15 were arranged at first intervals A over the entire length in the longitudinal direction on both the first longitudinal light source section 101 and the second longitudinal light source section 102. The first interval A was the same for the example and the comparative example.

As shown in FIG. 4, in the example, there was no difference in output voltage (quantity of the received light) between the longitudinal end portions of the illumination apparatus 1 and the other portions. To the contrary, in the comparative example, the output voltage locally decreased in the longitudinal end portions of the illumination apparatus 1. This shows that the example of the present invention has an effect of preventing a reduction of the light quantity in the longitudinal end portions of the illumination apparatus 1.

Although an embodiment of the present invention has been described in detail, the embodiment is given only as a specific example of the present invention. The technical scope of the present invention is not limited to the embodiment described above. Various modifications can be made without departing from the spirit of the present invention.

For example, although the illumination apparatus is incorporated in the sensor unit in the embodiment described above, the illumination apparatus according to the present invention is not limited to those incorporated in the sensor unit. The illumination apparatus according to the present invention can be incorporated in a wide variety of lighting equipment such as ceiling lighting equipment (a ceiling light, for example) or a desk lamp.

### INDUSTRIAL APPLICABILITY

The present invention is a technique suitable for an illumination apparatus and a sensor unit. According to the present invention, a reduction of the light quantity in longitudinal end portions can be prevented or reduced.

According to the present invention, reduction of the light quantity at the end portions in the longitudinal direction can be prevented.

1. An illumination apparatus, comprising:
a first longitudinal light source section that has a first substrate and a second substrate, which have an elongated shape and are arranged with end surfaces thereof in a longitudinal direction facing each other and on which a plurality of light sources are arranged in a line in the longitudinal direction; and
a second longitudinal light source section that has a third substrate and a fourth substrate, which have an elongated shape and are arranged with end surfaces thereof in a longitudinal direction facing each other and on which a plurality of light sources are arranged in a line in the longitudinal direction,
wherein the first longitudinal light source section and the second longitudinal light source section are arranged side by side in a short direction, and
the plurality of light sources on the first longitudinal light source section and the plurality of light sources on the second longitudinal light source section are displaced offset from each other in the longitudinal direction of the first longitudinal light source section and the second longitudinal light source section.

2. The illumination apparatus according to claim 1, wherein an interval between one group of light sources of the plurality of light sources on the first longitudinal light source section that are arranged in one end portion in the longitudinal direction and an interval between another group of light sources of the plurality of light sources that are arranged in another end portion in the longitudinal direction differ from an interval between the other light sources than the one group of light sources and the another group of light sources.

3. The illumination apparatus according to claim 2, wherein the number of the one group of light sources that are arranged in the one end portion of the first longitudinal light source section at intervals different from the intervals of the light sources other than the one group of light sources and the another group of light sources differs from the number of the another group of light sources that are arranged in the another end portion of the first longitudinal light source section at intervals different from the intervals of the light sources other than the one group of light sources and the another group of light sources.

4. The illumination apparatus according to claim 1, wherein an interval between one group of light sources of the plurality of light sources on the second longitudinal light source section that are arranged in one end portion in the longitudinal direction and an interval between another group of light sources of the plurality of light sources that are arranged in another end portion in the longitudinal direction differ from an interval between the other light sources than the one group of light sources and the another group of light sources.

5. The illumination apparatus according to claim 4, wherein the number of the one group of light sources that are arranged in the one end portion of the second longitudinal light source section differs from the number of the another group of light sources that are arranged in the another end portion of the second longitudinal light source section,
the number of the one group of light sources that are arranged in the one end portion of the second longitudinal light source section at intervals different from the intervals of the light sources other than the one group of light sources and the another group of light sources
differs from the number of the light sources arranged in the end portion in the longitudinal direction on the same side as the one end portion of the second longitudinal light source section and is equal to the number of the light sources arranged in the end portion in the longitudinal direction on the side opposite to the one end portion of the second longitudinal light source section, of the number of the one group of light sources that are arranged in the one end portion of the first longitudinal light source section at intervals different from the intervals of the light sources other than the one group of light sources and the another group of light sources and the number of the another group of light sources that are arranged in the another end portion of the first longitudinal light source section at intervals different from the intervals of the light sources other than the one group of light sources and the another group of light sources.

6. The illumination apparatus according to claim 1, wherein the one group of light sources of the first longitudinal light source section and the one group of light sources of the second longitudinal light source section are offset from each other in the longitudinal direction of the first longitudinal light source section and the second longitudinal light source section.

7. A sensor unit, comprising:
the illumination apparatus according to claim 1; and
a light condensing member and a sensor that are arranged between the first longitudinal light source section and the second longitudinal light source section of the illumination apparatus.

8. The sensor unit according to claim 7, wherein the sensor receives light emitted from an object to be read in accordance with light emitted by the illumination apparatus.

9. The sensor unit according to claim 7, wherein the sensor receives light that is emitted by the illumination apparatus and reflected by the object to be read.
